(19) United States
(12) Patent Application Publication
(10) Pub. No.: US 2006/0046009 A1
(43) Pub. Date: Mar. 2, 2006

(54) Optical disk

(75) Inventor: Takashi Horai, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/204,029

(22) Filed: Aug. 16, 2005

(30) Foreign Application Priority Data
Aug. 25, 2004 (JP) 2004-245817

(51) Int. Cl. B32B 3/02

(52) U.S. Cl. 428/64.1

(57) ABSTRACT

An optical disk having excellent recording characteristics at both low speed and high speed is provided by modifying a cyanine dye serving as a material of a recording layer such that the cyanine dye does not excessively remain in a groove in an optically transparent substrate. The optical disc comprises the recording layer on a surface of the optically transparent substrate, a reflective layer on the recording layer, and a protective layer on the reflective layer, wherein the recording layer contains at least one cyanine dye expressed by the following chemical formula I: 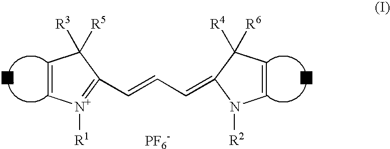
wherein, R¹, R² R³, R⁴, R⁵, and R⁶ are hydrocarbon groups, and A and B are independently a fused benzene ring or a fused naphthalene ring optionally having a substituent, and wherein the recording layer is formed by applying the at least one cyanine dye in a fluoroalcohol solvent to the optically transparent substrate.

### BACKGROUND OF THE INVENTION

1. Field of the Invention

The present invention relates to an optical disk, and particularly to a write-once read-many optical disk having excellent read-write characteristics at any recording speed ranging from low speed to high speed.

2. Description of the Related Art

As the progress of technology, various optical recording media, including a compact disc (CD) and a digital versatile disc (DVD), have been proposed and developed. Among these, recordable optical recording media include write-once read-many optical disks, such as a CD-R and a DVD-R.

In general, the write-once read-many optical disk contains an organic dye, such as an azo dye or a cyanine dye, as a recording material. The organic dye in a solvent is coated on a substrate to form a recording layer. Thus, it is important for the organic dye to have excellent recording characteristics at the wavelength of a laser beam applied to the organic dye and have adequate solubility in a solvent that does not erode the substrate.

For example, the cyanine dye that is presently used in a low-speed DVD-R, such as a single-speed (1×) DVD-R or a double-speed (2×) DVD-R, is designed to have adequate solubility in a fluoroalcohol solvent that is easier to handle in manufacturing. For example, Japanese Unexamined Patent Application Publication Nos. 2001-150816, 2002-246850, 2002-178640, 2002-206061, 2002-212454, and 2002-226731 disclose techniques for improving various recording characteristics, the durability, or the solubilities of cyanine dyes used in optical recording media.

In a conventional cyanine dye, the cyanine dye and a solvent are designed such that an appropriate amount of the cyanine dye remains in a groove in a substrate during spin coating. To satisfy the recent demand for high-speed recording, the optical disk is required to be recordable in a wide linear velocity range. However, use of the conventional dye and the solvent leaves excessive dye in the groove, causing thermal interference between recording marks. The thermal interference causes deterioration in recording characteristics. In the DVD-R, to satisfy the recent demand for both low-speed recording and high-speed recording, such as 4× or 8×, or even 16×, the problem of the thermal interference must be overcome.

Furthermore, in the DVD-R, a higher recording speed theoretically requires a higher output of a recording laser beam to write a recording signal. The higher output of the recording laser beam increases the width of a recording mark and accordingly increases the modulation factor. Thus, the DVD-R has the problem of the higher modulation factor due to the higher laser output in the high-speed recording. In a certain case, the recording mark overhangs a pre-pit in a land, making address control difficult. For the same reason, a wobble carrier to noise (CN) ratio decreases. This causes deterioration in the recording characteristics from 1× to 16×. In this regard, the modulation factor after writing is desirably 0.8 or less.

### SUMMARY OF THE INVENTION

Accordingly, it is an object of the present invention to provide an optical disk having excellent recording characteristics at any recording speed ranging from low speed to high speed by modifying a cyanine dye serving as a material of a recording layer such that the cyanine dye does not excessively remain in a groove in a substrate.

The present inventors have intensively studied the cyanine dye from the viewpoint of the solubility in a predetermined solvent. As a result, the present inventors have found that the amount of the cyanine dye in the groove can be appropriately controlled when the cyanine dye has a low solubility in the solvent, and thereby the thicknesses of the cyanine dye in the groove and on a land are appropriately controlled. The present invention is thus accomplished.

To overcome the problems described above, an optical disc according to the present invention comprises:

an optically transparent substrate;

a recording layer on a surface of the optically transparent substrate;

a reflective layer on the recording layer; and

a protective layer on the reflective layer,

wherein the recording layer contains at least one cyanine dye expressed by the following chemical formula I:

(I) 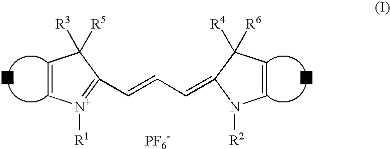
wherein, R¹ and R² may be the same or different and are independently a hydrocarbon group having 1 to 4 carbon atoms, R³, R⁴, R⁵ and R⁶ may be the same or different and are independently a hydrocarbon group having 1 to 10 carbon atoms, and A and B may be the same or different and are independently a fused benzene ring or a fused naphthalene ring, the fused benzene ring or the fused naphthalene ring optionally having a substituent, such as a halogen atom, a nitro group, and a hydrocarbon group having 1 to 4 carbon atoms, and

wherein the recording layer is formed by applying the at least one cyanine dye in a fluoroalcohol solvent to the optically transparent substrate. Preferably, the amount of the at least one cyanine dye expressed by the chemical formula I is at least 40% by mole of the solid content of the recording layer. Preferably, the fluoroalcohol solvent is 2,2,3,3-tetrafluoro-1-propanol (TFP).

In general, the solubility of the cyanine dye in the solvent can be altered by changing a counter ion in the cyanine dye while the refractive index and the extinction coefficient of the cyanine dye are almost constant. The present inventors investigated the relationship between the solubility of the cyanine dye and the amount of the cyanine dye left in the groove by changing the counter ion and therefore the solubility of the cyanine dye. As a result, the present inventors have found that the thicknesses of the cyanine dye in the groove and on the land are appropriately controlled when the cyanine dye has a low solubility in the solvent, rather than a high solubility as in the conventional cyanine dye. Such a cyanine dye satisfies the requirements described above and can reduce the thermal interference at high-speed recording. Specifically, the solubility of the cyanine dye in the fluoroalcohol solvent is preferably in the range of 8 to 60 mg/ml at 20° C. When solubility of the cyanine dye is in this range, the thickness of the recording layer in the groove can be controlled between 30 to 120 nm.

Thus, in the optical disk having such a structure according to the present invention, an excessive amount of the cyanine dye is prevented from remaining in the groove. The optical disk is recordable at any recording speed ranging widely from low speed to high speed. Thermal interference rarely occurs at any recording speed ranging from low speed to high speed, and thereby both excellent jitter characteristics and a smaller increase in the modulation factor can be achieved. Thus, the optical disk having excellent recording characteristics can be provided.

### BRIEF DESCRIPTION OF THE DRAWINGS

FIG. 1 is a schematic fragmentary sectional view showing the vicinity of a groove in an optical disk according to an embodiment of the present invention; and

FIG. 2 is a schematic fragmentary sectional view showing the vicinity of a groove in an optical disk according to a Comparative Example 2 of the present invention.

### DESCRIPTION OF THE PREFERRED EMBODIMENTS

An embodiment of the present invention will be described in detail below.

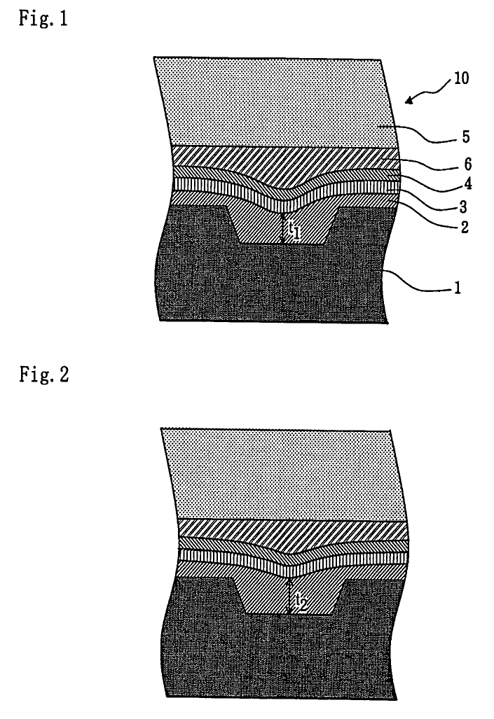

FIG. 1 is a schematic enlarged fragmentary sectional view showing the vicinity of a groove in an optical disk according to an embodiment of the present invention. The optical disk 10 includes a recording layer 2, a reflective layer 3, a protective layer 4, and an adhesive layer 6, stacked on a surface of an optically transparent substrate 1 in this order (the adhesive layer may also serve as the protective layer). The optical disk 10 also includes a dummy substrate 5 on the adhesive layer 6. The optical disk 10 is a so-called write-once read-many optical disk, in which information is recorded by forming a recording mark in the recording layer 2 with a laser beam incident from the optically transparent substrate 1. The optical disk according to the present invention can be suitably used at any recording speed ranging from low speed to high speed, specifically, at 1× to 16× (3.49 to 56.0 m/s) in the DVD-R.

In the present invention, the recording layer 2 contains at least one cyanine dye expressed by the following chemical formula I:

(I) 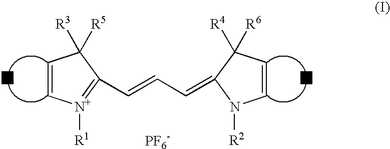
wherein, R¹ and R² may be the same or different and are independently a hydrocarbon group having 1 to 4 carbon atoms, R³, R⁴, R⁵ and R⁶ may be the same or different and are independently a hydrocarbon group having 1 to 10 carbon atoms, and A and B may be the same or different and are independently a fused benzene ring or a fused naphthalene ring optionally having a substituent, such as a halogen atom, a nitro group, and a hydrocarbon group having 1 to 4 carbon atoms.

This cyanine dye has a relatively low solubility in a fluoroalcohol solvent that is used for forming the recording layer 2. Specifically, the solubility of the cyanine dye in the fluoroalcohol solvent at 20° C. is preferably in the range of 8 to 60 mg/ml, and more preferably in the range of 15 to 45 mg/ml. To achieve the present invention more effectively, the cyanine dye suitably should have the lowest possible solubility provided that the cyanine dye is not precipitated out of its fluoroalcohol solution.

In the present invention, the content of the cyanine dye is preferably at least 40% by mole, and more preferably in the range of 60% to 90% by mole of the solid content of the recording layer 2. When the content of the cyanine dye is less than 40% by mole, an excessive amount of the cyanine dye cannot be prevented from remaining in the groove. Thus, the recording characteristics at a high recording speed will be deteriorated. However, the content of the cyanine dye may be less than 40% by mole when another cyanine dye that is bound to an organic anion to form a salt is added to the fluoroalcohol solution and the total amount of the cyanine dye skeleton is at least 40% by mole, and particularly in the range of 60% to 90% by mole.

The recording layer 2 may further contain an organic dye, such as an azo dye or a phthalocyanine dye, alone or in combination. If desired, the recording layer 2 may further contain a singlet oxygen quencher or a UV absorber. The ionic combination between a dye cation and a singlet oxygen quencher anion is also preferred as the organic dye.

The recording layer 2 may be formed by applying a coating solution, which is prepared by dissolving the cyanine dye in the fluoroalcohol solvent, to the optically transparent substrate 1 by spin coating. It is desirable that the recording layer 2 may be formed such that the total concentration of the organic dyes in the coating solution and the thickness of the organic dye film are adjusted to provide an adequate reflectance from the reflective layer 3. The thickness of the recording layer 2 is not limited to a specific value and may be determined as required. The thickness of the recording layer 2 in the groove is preferably in the range of 30 nm to 120 nm, and more preferably in the range of 40 nm to 100 nm. Preferably, the groove in the optically transparent substrate 1 has the width of 0.29 to 0.36 μm and the depth of 0.14 to 0.18 μm.

The fluoroalcohol solvent used in the coating solution of the recording layer 2 is not limited to a specific solvent; any fluoroalcohol solvent may be used alone or in combination. Preferably, the fluoroalcohol solvent is 2,2,3,3-tetrafluoro-1-propanol (TFP), which has a boiling point over 60° C. Although a fluoroalcohol having a boiling point below 60° C. can be vaporized under typical conditions of high temperature and high humidity in the coating process of the organic dye, the drying speed is too fast to form a uniform organic dye film. The solvent used is required not only to dissolve the organic dye, but also not to damage the optically transparent substrate 1.

The number of revolutions in the spin coating of the recording layer 2 is not limited to a specific number. When the dye solution is spread over the optically transparent substrate 1, the number of revolutions is preferably set to be about 100 to 500 rpm, and more preferably 3000 to 5000 rpm. Under this condition, the time to reach this number of revolutions and the holding time at the number of revolutions are appropriately controlled.

The dye solution may be applied to the optically transparent substrate 1 by the spin coating and may be dried at 50° C. for 2 hours or 80° C. for 30 minutes. Then, the reflective layer 3 is formed on the resulting recording layer 2. The thickness of the reflective layer 3 is, for example, about 10 to 500 nm. The reflective layer 3 may be composed of Au, Ag, Cu, Cr, Ni, Si, Ge, Pd, Nd, In, Sn, or Bi, alone or in combination. The reflective layer 3 may be formed by sputtering. Preferably, the reflective layer 3 contains Ag. More preferably, the reflective layer 3 contains at least 95% of Ag.

The protective layer 4 having a thickness of 1 to 50 μm is formed on the reflective layer 3. The protective layer 4 protects the recording layer 2 and the reflective layer 3 and may be made of any material. In general, the protective layer is made of a UV-curable acrylic resin because of the easiness of handling. The protective layer may also be made of an organic material, such as a vinyl chloride resin, an epoxy resin or a polyester resin, or an inorganic material, such as SiO₂ or AlN. These materials may be used alone or in combination. Furthermore, the protective layer 4 may have a multilayer structure, for example, of different materials.

The dummy substrate 5 is disposed over the protective layer 4. If desired, the protective layer 4 and the dummy substrate 5 may be separated by the adhesive layer 6 and/or a label-printing layer (not shown). Any adhesive may be used to laminate the dummy substrate 5. The adhesive layer 6 may also serve as the protective layer for the reflective layer 3. While the protective layer 4 is preferably formed by the spin coating to prevent damage to the reflective layer 3, the protective layer 4 may also be formed by screen printing, dipping, or spray coating.

The optically transparent substrate 1 may be made of a polymer material, such as a polycarbonate (PC) resin, an acrylic resin, a polystyrene resin, an epoxy resin, a polyester resin, a polyvinyl chloride resin or an olefin resin, or an inorganic material, such as glass. The optically transparent substrate 1 can be produced by transferring a pregroove in a mold to the resin material mainly by injection molding, or to a glass material mainly by a 2P method. The dummy substrate 5 may be produced using the same material as in the optically transparent substrate 1. However, when a laser beam is not applied to the recording layer 2 from the side of the dummy substrate 5, the dummy substrate 5 is not necessarily transparent, unlike the optically transparent substrate 1.

### EXAMPLES

The present invention will be described below with reference to Examples and Comparative Examples.

### Example 1

A cyanine dye having the following chemical formula II was prepared, wherein the counter ion (X⁻) was PF₆⁻.

(II)

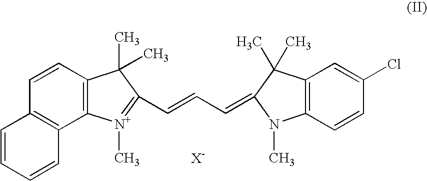

This cyanine dye was dissolved in 2,2,3,3-tetrafluoro-1-propanol at a concentration of 14 mg/ml. The cyanine dye solution was applied to an optically transparent substrate 1 by spin coating to form a recording layer 2.

Then, a reflective layer 3 was formed on the recording layer 2. A top coat was applied to the reflective layer 3 to form a protective layer 4. A dummy substrate 5 was laminated on the protective layer 4. In this way, an optical disk 1 was manufactured.

### Example 2

An optical disk 1 was manufactured by the same procedures as in the Example 1, except that the cyanine dye having the chemical formula II in the Example 1 was replaced by a cyanine dye having the following chemical formula III.

(III)

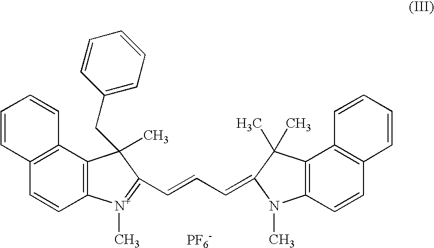

### Example 3

An optical disk 1 was manufactured by the same procedures as in the Example 1, except that the cyanine dye having the chemical formula II in the Example 1 was replaced by 50% by mole of cyanine dye having the chemical formula III and 50% by mole of cyanine dye having the chemical formula IV.

(IV)

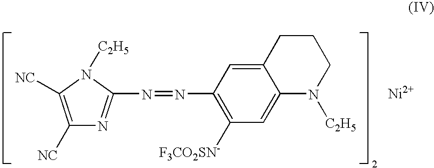

### Comparative Example 1

An optical disk 1 was manufactured by the same procedures as in the Example 1, except that the counter ion (X⁻) of the compound II in the Example 1 was replaced by ClO₄⁻.

### Comparative Example 2

An optical disk 1 was manufactured by the same procedures as in the Example 1, except that the counter ion (X⁻) of the compound II in the Example 1 was replaced by I⁻.

A push-pull signal (Pu—Pu) was measured with a DDU-1000 (Pulstec Industrial, Co., Ltd.) for the optical discs that were manufactured in Examples 1 to 3 and Comparative Examples 1 and 2 and were not recorded yet. Then, a random signal was written on the optical discs with the DDU-1000 (wavelength: 660 nm) at constant linear velocities (CLV) of 3.49 m/s (1×), 14.0 m/s (4×), and 56.0 m/s (16×). The random signal was regenerated with the DDU-1000 (wavelength: 650 nm). The thermal interference asymmetry, the modulation factor, and the bottom jitter were determined. The write strategies were selected to optimize the jitters at 1×, 4×, and 16×.

Table 1 shows the results and the solubility of the cyanine dyes in 2,2,3,3-tetrafluoro-1-propanol. FIGS. 1 and 2 are schematic fragmentary sectional views showing the vicinities of grooves in the optical disks according to Example 1 (counter ion: PF6⁻) and Comparative Example 2 (counter ion: I⁻), respectively. As shown in FIGS. 1 and 2, the thickness t₁ of the dye in the groove in Example 1 (the thickness of the recording layer) is smaller than the thickness t₂ of the dye in the groove in Comparative Example 2. Thus, the optical disk in Example 1 has more uniform dye

| | | | | Comparative | Comparative |
|---|---|---|---|---|---|
| | Example 1 | Example 2 | Example 3 | Example 1 | Example 2 |
| Pu-Pu before recording | 0.31 | 0.38 | 0.32 | 0.17 | 0.11 |
| Solubility in TFP | 15 | 8 | 45 | 76 | 0.11 |
| (mg/ml) | | | | | |
| Thermal interference | 12.5 | 16.0 | 15.1 | 4.3 | 1.0 |
| asymmetry (%) | | | | | |
| Modulation facter at 1X | 0.588 | 0.598 | 0.585 | 0.599 | 0.596 |
| Modulation facter at 4X | 0.649 | 0.658 | 0.656 | 0.661 | 0.652 |
| Modulation facter at 16X | 0.659 | 0.668 | 0.68 | 0.67 | 0.661 |
| Bottom jitter at 1X (%) | 7.8 | 7.6 | 7.6 | 7.8 | 7.9 |
| Bottom jitter at 4X (%) | 7.5 | 6.8 | 6.9 | 9.3 | 12.9 |
| Bottom jitter at 16X (%) | 7.4 | 7.4 | 7.8 | 14.3 | 18.4 |

film over the land and the groove than the optical disk in Comparative Example 2.
[Table 1]

The Pu—Pu value before recording increases with increasing difference between the distance from a laser source to the land and the distance from the laser source to the groove. Thus, improved tracking of the laser beam also contributes to excellent recording characteristics. This demonstrates that the amount of dye in the groove is not excessive, and is appropriate for recording. The bottom jitter indicates the signal quality after recording; a smaller bottom jitter indicates better signal quality. The thermal interference asymmetry indicates a signal depth at which the recording signal begins to deteriorate because of the thermal interference. The thermal interference tends to occur at a higher laser output and therefore a larger asymmetry. This narrows the recording power margin. Thus, an excellent recording medium having a wider margin has a larger asymmetry at which thermal interference occurs. The optical discs in Examples 1 to 3 have much larger asymmetries than those in Comparative Examples 1 and 2. Ideally, the modulation factor is almost constant between 1× and 16×. The modulation factors after 16× writing in Examples 1 to 3 are less than 1.3 times as large as the modulation factors after 1× writing.

Although the reason that the use of the cyanine dye having a lower solubility prevents the thermal interference is not clear, one explanation may be as follows. Since the solution containing the cyanine dye having a lower solubility has a larger kinematic viscosity, a dye layer is easily formed along the groove in the optically transparent substrate during the spin coating. This results in an appropriate amount of dye in the groove, and a suitable thickness distribution over the land and the groove for recording speeds ranging from low speed to high speed. Thus, the total signal quality (jitter) is improved and the thermal interference is prevented.

As described above, according to the present invention, an excessive amount of the cyanine dye is prevented from remaining in the groove, and thereby the optical disk is recordable at any recording speed ranging from low speed to high speed. Thus, the optical disk having excellent recording characteristics at any recording speed ranging from low speed to high speed, and a method for manufacturing the optical disk can be provided.

1. An optical disc comprising:
an optically transparent substrate;
a recording layer on a surface of the optically transparent substrate;
a reflective layer on the recording layer; and
a protective layer on the reflective layer,
wherein the recording layer comprises at least one cyanine dye expressed by the following chemical formula I:
(I) 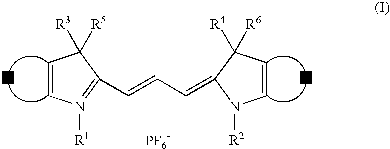
wherein, R¹ and R² may be the same or different and are independently a hydrocarbon group having 1 to 4 carbon atoms, R³, R⁴, R⁵ and R⁶ may be the same or different and are independently a hydrocarbon group having 1 to 10 carbon atoms, and A and B may be the same or different and are independently a fused benzene ring or a fused naphthalene ring, the fused benzene ring or the fused naphthalene ring optionally having a substituent, such as a halogen atom, a nitro group, and a hydrocarbon group having 1 to 4 carbon atoms, and
wherein the recording layer is formed by applying the at least one cyanine dye in a fluoroalcohol solvent to the optically transparent substrate.

2. The optical disk according to claim 1, wherein the amount of the at least one cyanine dye expressed by the chemical formula I is at least 40% by mole of the solid content of the recording layer.

3. The optical disk according to claim 1 or 2, wherein the fluoroalcohol solvent is 2,2,3,3-tetrafluoro-1-propanol.

4. The optical disk according to any one of claims 1 through 3, wherein the cyanine dye has a solubility of 8 to 60 mg/ml in the fluoroalcohol solvent at 20° C.

5. The optical disk according to any one of claims 1 through 4, wherein the thickness of the recording layer in a groove in the substrate is in the range of 30 to 120 nm.
